(19) United States
(12) Patent Application Publication
(10) Pub. No.: US 2015/0013210 A1
(43) Pub. Date: Jan. 15, 2015

(54) Trigger Happy Comfort Grip for Spinning Reels

(71) Applicant: Loren Pernell Jenkins, Elk Groove, CA (US)

(72) Inventor: Loren Pernell Jenkins, Elk Groove, CA (US)

(21) Appl. No.: 14/320,658

(22) Filed: Sep. 12, 2014

Related U.S. Application Data
(60) Provisional application No. 61/957,420, filed on Jul. 2, 2013.

(51) Int. Cl. A01K 87/08; A01K 87/06; A01K 89/00

(52) U.S. Cl. CPC A01K 87/08; A01K 89/00; A01K 87/06
USPC 43/23; 43/20

(57) ABSTRACT

A grip for all spinning fishing reels is disclosed which has a resiliently flexible rubber hollow tubular shape (interior) with the ability to employ a variety of exterior surface textures, including knurls, waves, ribs, etc. The grip is shaped so that it provides a uniform fit over the spinning reel support arm on spinning reels, the opening regardless of its shape provides a uniform fit on the spinning reel arm once the grip is employed and in position. The rubber conforms to any shape and size of spinning reel arm and compresses uniformly to provide a custom fit. The radial thickness of the grip is smaller in comparison to the grip, yet generally mirrors the overall shape of the exterior of the grip with the exception of the chosen external surface texture which can vary. The grip itself, during use compresses and conforms to the individual user's hands and fingers.

### FIELD OF THE INVENTION

This invention relates to the ergonomic improvements that afford the user a comfortable, non-impeding grip mechanism to relieve pain and discomfort and reduce slippage that can be experienced from the hand and fingers applying constant pressure on the hard spinning reel support arm during angling.

### BACKGROUND OF THE INVENTION

Spinning type fishing reels are fashioned with a hard support arm that helps the user grip the reel and provide leverage during all related fishing/angling activities which include casting, retrieving and fighting fish. During all of these activities an amount of force is required to maintain the grip on the fishing reel. The hands and fingers work in unison to provide these activities whereby an amount of strain is placed upon the hands and fingers due to the hard material composition of the spinning reel support arm contacting the flesh and skin of the user.

In order to provide comfort for the hands and fingers, particularly in between the fingers where the hard support arm actually contact the skin, the soft ergonomic grip is employed. The grip provides a soft pleasurable feeling for the user which allows the user to complete all of the functions and activities of angling, less the pain that can be associated by grasping the hard support arm.

In addition, the grip also provides a mechanism to improve the grasp and reduce slippage by providing a tacky surface to the support arm.

### SUMMARY OF THE INVENTION

The grip for a spinning type fishing reel of this invention has a resilient soft rubber composition receptacle. The inner wall of the grip is smaller in comparison to the outer wall, but mirrors its general shape although the external features and surface texture can vary. The soft, resilient quality of the grip allows the grip to “receive” and conform to the shape of the spinning reel support arm.

It is an object of the present invention to provide comfort to the user who is grasping the spinning reel support arm.

It is an object of the present invention to provide a grip that reduces hand/finger slippage during angling.

It is an object of the present invention to provide a spinning reel grip that can accommodate a variety of spinning reel support arm shapes and sizes.

It is a further object of the present invention to reduce pain in the hands and fingers by providing a soft cushion over the hard support arm of the spinning reel.

### BRIEF DESCRIPTION OF THE DRAWINGS

FIG. 1 shows a front view of a conventional prior art spinning type fishing rod.

FIG. 2 shows a front view of a conventional prior art spinning type fishing reel.

FIG. 3 shows a front view of the spinning reel attached to the spinning rod and the spinning reel grip installed and firmly in place.

FIG. 4 shows an isometric view of the spinning reel grip.

FIG. 5 shows a front view of the spinning reel grip in use and installed on the support arm of the spinning reel.

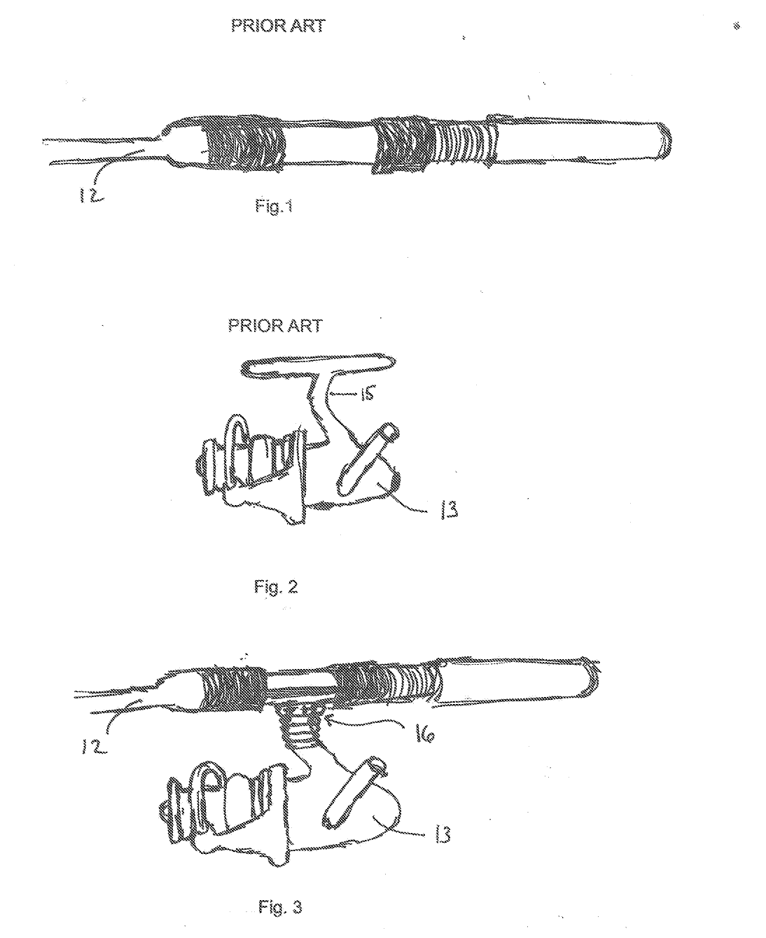

### DESCRIPTION OF THE PREFERRED EMBODIMENT

Referring more particularly to the images, wherein like numbers refer to similar parts, FIGS. 3-5 show a Spinning reel comfort grip 16 for spinning reels 13. The spinning reel comfort grip is formed of a moldable, resilient rubber material, yet can vary in their basic shape and construction.

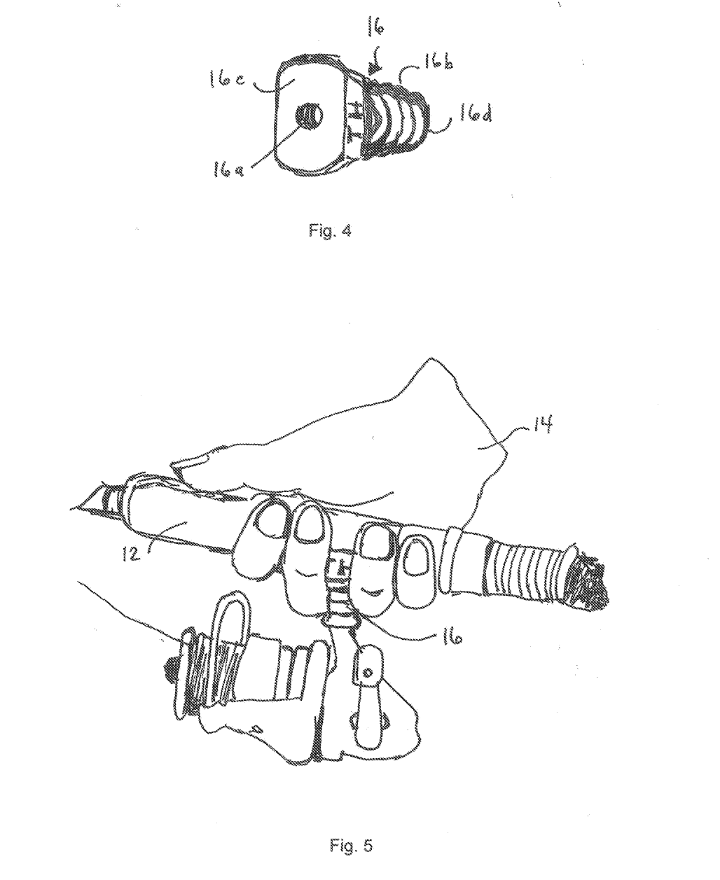

As shown in FIG. 4 the body 16b of the grip 16 can have a variety of shape and construction but will typically be between 1″ and 1 ⅛″ in length.

As shown in FIG. 4 the grip 16 includes a tubular-shaped main inner wall 16a and a consistently shaped exterior wall 16b. The main inner wall 16a includes an opening of the grip 16. The grip 16 further includes a flange 16c and the exterior wall 16b includes external surfaces 16d. The external surfaces 16d can have a variety of possible external surfaces. In the instant example of FIG. 4, the external surfaces 16d are ribs 16d.

An effective grip of the flexible material will tend to apply a compressive force to the grip 16, serving to keep the grip in place when grasped between the angler's fingers as shown in FIG. 5.

The Trigger Happy Spinning Reel Grip 16 has resilient cushioning effects and conform to the size, shape and any features or effects such as jewelry, etc. that may be on the fingers and provide a spongy sensation and comfort without the loss of sensitivity in the rod and reel as employed in angling methods.

As seen in FIG. 3, the grip 16 extends about an exterior periphery of the spinning reel support arm 15. The opening of the grip receives and conforms to the shape of the support arm 15. The main inner wall 16a elastically grips the support arm 15 to secure the grip 16 to the support arm 15. The grip 16 employs a grabbing effect on the support arm 15. The flexible material of the grip 16 itself resiliently deforms when the user grasps the support arm between their fingers.

It is understood that the invention is not confined to the particular construction and arrangement of parts herein illustrated and described, but embraces all such modified forms thereof as come within the scope as claimed.

1. A fishing reel in combination with a removable grip, the fishing reel including a support arm projecting from a main body of the fishing reel;
wherein the grip including a tubular-shaped inner wall forming a through opening; and,
wherein the grip encloses a portion of the support arm from an exterior periphery of the support arm;
wherein the grip further includes an exterior wall.

2. The combination as claimed in claim 1, wherein the tubular shaped inner wall is resiliently deformable to conform to the shape of the support arm and elastically grips the support arm to secure the grip to the support arm.

3. The combination as claimed in claim 2, wherein the external wall comprises a resiliently flexible material to allow a user to grasp the support arm of the reel between two fingers while the grip conforms to the fingers.

4. The combination as claimed in claim 1, wherein the grip further includes external projections on the exterior wall to provide gripping areas.

5. The combination as claimed in claim 4, wherein the external projections are ribs.

6. The combination as claimed in claim 4, wherein the grip further includes a peripheral flange extending perpendicular to a longitudinal axis of the through opening.

7. A removable grip including an opening including a tubular-shaped inner wall forming a through opening; and,
wherein the grip further includes an exterior wall.

8. The removable grip as claimed in claim 7, wherein the tubular shaped inner wall is resiliently deformable to conform to a support arm of a fishing reel.

9. The removable grip as claimed in claim 8, wherein the external wall comprises a resiliently flexible material to allow a user to grasp the fishing reel between two fingers while the grip conforms to the fingers.

10. The removable grip as claimed in claim 7, wherein the grip further includes external projections on the exterior wall to provide gripping areas.

11. The combination as claimed in claim 10, wherein the external projections are ribs.

12. The removable grip as claimed in claim 10, wherein the grip further includes a peripheral flange extending perpendicular to a longitudinal axis of the through opening.
